(19) United States
(12) Patent Application Publication
(10) Pub. No.: US 2012/0143678 A1
(43) Pub. Date: Jun. 7, 2012

(54) COLLABORATION RECOMMENDATION AND EMBEDDED TRIGGER SELECTION IN DISTRIBUTED HETEROGENEOUS MEDIUMS

(76) Inventors: Ajay SATHYANATH, Edison, NJ (US); Thyaga NANDAGOPAL, Edison, NJ (US)

(21) Appl. No.: 12/961,864

(22) Filed: Dec. 7, 2010

(51) Int. Cl. G06Q 30/00

(52) U.S. Cl. 705/14.46; 705/14.49

(57) ABSTRACT

A method of determining relevance values for triggers, in order to select relevant embedded triggers to be displayed with ads and/or content shown on billboards of various media types. The method includes determining a potential relevance of preselected ads and/or content that may provide a threshold relevance value for all triggers that are to be displayed with the preselected ad and/or content. Relevance values and potential relevance are determined by summing entity values. Entity values are determined by multiplying entity weights by a summation of keyword weights. Entity weights and keyword weights may be assigned based on industry experience or based on the ability of displayed entities and/or displayed keywords to generate revenue.

### BACKGROUND OF THE INVENTION

1. Field of the Invention

Example embodiments relate generally to a method of selecting relevant embedded triggers to be displayed with ads and/or content shown on billboards of various media types. Example embodiments also provide a method of determining the potential relevance of embedded triggers that may be displayed with ads and/or content.

2. Related Art

Billboards and other advertising media today are discrete hardware or software structures that operate independently of each other to display messages and/or advertising. Billboards may include physical structures, or they may include content and advertisement on the internet websites, television, cell phones, newspapers (print or online), magazines, movie theatres, etc. Conventionally, billboard operators own and operate multiple billboards in a geographic region, where each individual billboard shows a single continuous advertisement or message (or, some content with an ad). Some limited methods of collaboration include triggers limited to tracking the identity of viewer SMS/phone numbers which are limited to tracking viewership of a single advertisement. However, the location of the billboard and the precise time at which the billboard is viewed is generally not tracked in conjunction with identifying information of the viewer audience. Further more, no collaboration is currently used between the billboards (whether the collaboration is between billboards of a same medium, or of heterogeneous media). Specifically, data from one billboard is not used to influence what is displayed on another billboard. Additionally, no tracking of viewer profiles and/or viewer identity is currently used to track viewers/consumers across various heterogeneous media types. Therefore, a maximization of cumulative viewership of all content/ads over all billboards in a region is not realized.

### SUMMARY OF INVENTION

Example embodiments provide a system/arrangement and a method for tracking viewership of content and advertisements across regional billboards using triggers. The triggers may provide feedback to collaborate content/ads across a single medium or a number of heterogeneous media types to maximize cumulative viewership and advertising effectiveness. The tracking of the viewership may be accomplished via embedded triggers tailored to the physical location of the billboard (in any display media), the time a particular content and/or ad is displayed on the billboard, the identity of the content and/or ad, and identifying information of the viewer (including a total number of viewers, interests and/or consumer preferences of individual viewers, generally interests of groups of viewers, frequency of viewership, other billboards viewed by a viewer, etc.). The triggers may be independent of the actual content or the ad. By associating the identity of the trigger with identification of the viewer, the identity of the content and/or ad on the billboard, the location of the billboard, and the time the billboard was actually viewed, the billboard operator can track viewership regardless of when the trigger was actually executed. By collecting this data, the cumulative viewership of content/ads may be managed across billboards distributed across a region and across heterogeneous media.

Example embodiments also provide a method of selecting relevant embedded triggers that may be displayed with ads and/or content. Additionally, example embodiments provide a method of determining the potential relevance of embedded triggers that may be used with selected ads and/or selected content.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a content collaboration arrangement including a content collaboration system, in accordance with an example embodiment;

FIG. 2A is a billboard showing a general relationship between a main content, a contextual advertisement and a trigger, in accordance with an example embodiment;

FIG. 2B is a billboard showing a general relationship between only a contextual advertisement and a trigger, in accordance with an example embodiment;

FIG. 3 is a method of determining the relevance of a finite set of embedded triggers based on a selected ad and/or content, in accordance with an example embodiment; and

FIG. 4 is a method of determining the potential relevance of an embedded trigger that may be displayed with a selected ad and/or content, in accordance with an example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

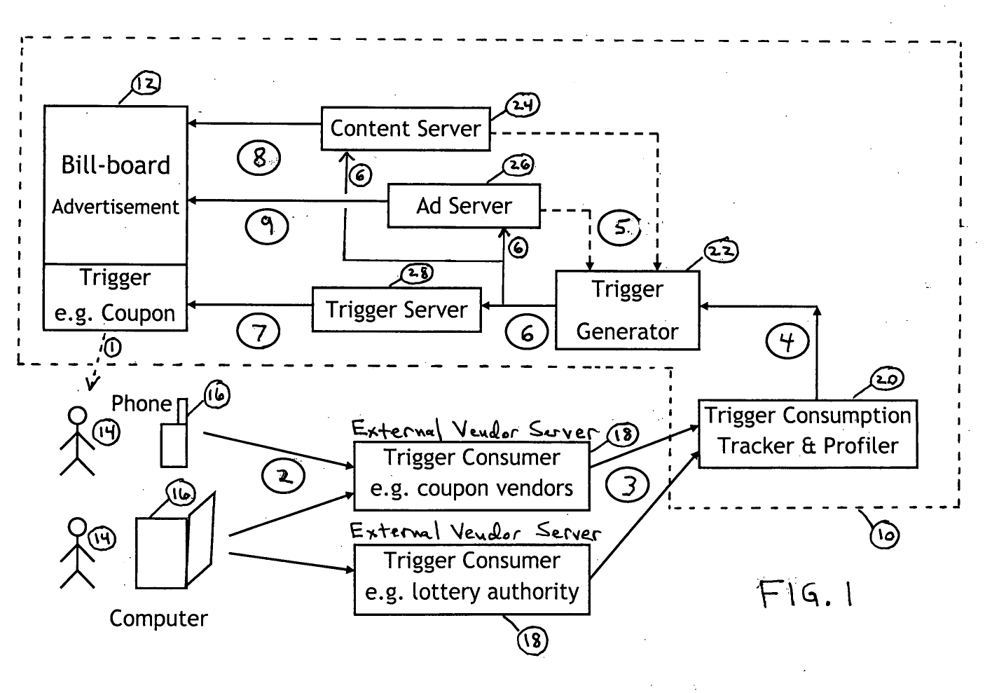

FIG. 1 is a content collaboration arrangement including a content collaboration system 10, in accordance with an example embodiment. The arrangement includes various billboards 12 containing content and/or advertising. A billboard 12 includes any structure, software and/or hardware capable of displaying images and messages on a medium for viewing by a target audience. A billboard may be a physical structure, such as billboards that are commonly found along interstates, shopping malls and movie theatres. A billboard may also include a website, a banner on a website (such as an advertisement banner), or a distributed email that may be transmitted to consumers or the general public. Furthermore, a billboard may include advertisements or messages on television or part of the trailer of a movie. Furthermore, a billboard may be an advertisement or message on a cell-phone or tablet. Furthermore, a billboard may be a newspaper or magazine (either in print or on-line). The definition of “billboard” is not limited by these examples, as the intended meaning of this term envelopes any means of displaying images and messages to a viewer.

The billboard 12 may display a trigger. The trigger may take a number of forms. For instance, the trigger may be a redeemable coupon with a specific coupon number (serial number) or it may be a game cheat code with an identifiable number that may be used in a computer game. A trigger may lend itself to identifying the viewer or the user that executes the trigger. The trigger may be related to the content/ad (for instance, the content/ad may be for a brand of coffee, and the trigger may be a redeemable coupon for a free cup of coffee) or the trigger may be unrelated to the content/ad (for instance, the content/ad may be for a brand of coffee, and the trigger may be a game cheat code of a computer game).

Viewers 14 may see the content/ad as well as seeing the trigger 1. Viewers may then use any number of devices 16 such as a cell phone or a laptop computer to then execute the trigger 2. Alternatively, devices 16 are not necessarily needed to execute triggers. For instance, using the example of the redeemable coffee coupon, a viewer 14 may use a computer 16 to access the coffee manufacturer's website (an external vendor server 18) to enter a coupon number to have a free sample of coffee shipped to the viewer. Alternatively, the viewer 14 may email the manufacturer (again accessing vendor server 18) to provide the coupon number. Furthermore, the viewer 14 may use a cell phone 16 to text the coupon number to a vendor phone number (used in conjunction with a vendor server 18 used to track the exchanges). Or the viewer 14 may provide a coupon number or serial number to a vendor server 18 to then enter the viewer in a lottery drawing. Additionally, rather than using a device 16, the viewer 14 may instead walk into a shop and redeem the coupon, in which case the transaction associated with the redemption of the coupon is stored/tracked by the vendor server 18. Using any of these methods of executing a trigger 1, the vendor server 18 obtains both identifying information associated with the trigger itself (i.e., a coupon with unique identifying numbers/letters/symbols) as well as identifying information of the viewer. Identifying information of the viewer may include the viewer's phone number, home address, email address, IP address, or other types of contact information. Identifying information of the viewer may also include demographic information such as their age, occupation, citizenship, school district, their affiliation to various groups or organizations, or any other identifying information that may be of interest to a billboard operator. Identifying information may further include consumer preferences such as their interest in a full-sized versus compact car, their needs associated with value versus cost of consumer goods, or their favorite name brands. Identifying information may also include personal information such as a viewer's driver's license number, social security number, height and weight, etc.

Once the vendor server 18 has collected identifying information on both the trigger and the viewer, this data 3 may then be transmitted to a trigger consumption tracker and profiler 20 within a content collaboration system 10. The tracker/profiler 20 may compile data related to an identity of executed triggers that have been displayed on billboards across a region and across heterogeneous media. Because each trigger has a unique identifier, the tracker/profiler 20 may become aware of the precise time and location upon which the billboard was viewed. Identifying information of the trigger may be thought of as meta-data. For instance, a unique trigger identification number may be changed every hour on a movie advertisement billboard such that viewership as a function of time (i.e., 12:00 p.m. to 1:00 p.m., 3:00 a.m. to 4:00 a.m.) may then be tracked. A unique identifier may be provided for billboards in train stations which may be different from billboards at a local mall. A unique identifier for Internet advertisements may be different from billboards posted on a highway overpass. In each instance, the trigger may include a unique identifier able to identify the location and specific media used to display a trigger (i.e., the unique identifier identifies the geographic location of the billboard, and the media upon which the billboard was displayed such as the Internet, television, a specific television show or movie, a physical billboard, etc.) and the time upon which the trigger was displayed (i.e., a specific time slot, date, season, year, etc. upon which the trigger was shown on the billboard).

The tracker/profiler 20 may provide tracking/profiling information 4 on identifying information associated with the trigger and the viewer to a trigger generator 22. The tracker/profiler 20 and the trigger generator 22 may be separate components or they may be a same component. The tracker/profiler 20 and the trigger generator 22 may be hardware, software, or a combination of software/hardware with associated storage that may be run on a computer, a personal computer (PC), a main-frame computer, or a dedicated machine used solely to provide the functionality described in this document. Furthermore, the trigger consumption tracker/profiler 20 may take the place of the external vendor servers 18, rather than having external vendor servers 18 that are separate from the tracker/profiler 20.

The trigger generator 22 may combine the tracker/profiler 20 data with data on available content 5 (from a content server 24 of potential content that may be available to display) and data on available advertising 5 (from an ad server 26) to then generate a control signal 6. The control signal 6 may be sent to a trigger server 28 that contains a listing of available triggers. The control signal 6 may be used to command the trigger server to display a trigger 7 on one or more billboards 12 that may be displayed across a number of media. The control signal may also be used to command the ad server 26 and/or content server 24 to also display an ad and/or content on the billboards 12 as well. The control signal 6 may be generated based on a determination of the success of previously executed triggers which were included in previous billboards 12 with ads and/or content.

A determination of the “success” of previous triggers may include threshold statistical markers such as a determination of the percentage of executed triggers that were executed by a target demographic of viewers (i.e., if a particular media type is better at reaching a target demographic, a shift in focus to more triggers on that particular media type may be preferred). A determination of “success” may also be the way in which various heterogonous media may maximize revenue (i.e., if it is determined that a less expensive media was actually more successful in reaching consumers, a shift in focus toward the less expensive media may be preferred). Likewise, “success” may be determined based on the overall number of executed triggers having been reached by a particular media type, or by a group of one or more billboards (i.e., if the number of desired executed triggers was reached, a shift in using the billboards for other purposes may be preferred). Further, “success” may be determined based on the number of triggers executed in a certain period of time (i.e., if it is determined that 80% of all executed triggers for train stations occurred based on billboard postings between 10:00 a.m. and 5:00 p.m., a shift in focus toward the use of triggers on billboards during those times may be preferred). Further, “success” may be determined based on the particular pairing of a trigger with a specific content and/or ad. For instance, if a particular trigger is “successful” independently of the identity of either the content or the ad, a shift in using that particular trigger only with higher revenue advertisements may be preferred. Likewise, if particular triggers are found only to be “successful” when paired with a particular ad or content, a shift in using the trigger only with the specific content and/or ad that causes the triggers success may be found to be preferred. It should be understood that the “success” of a trigger is generally subjective and therefore the feedback control of the content collaboration system 10 may be tailored to meet the specific needs of the billboard owner to increase viewership over specific locations, specific media types, and/or specific times to increase the overall effectiveness of the billboards 12. Furthermore, due to the subjective nature of the “success” of a trigger, an individual may manually determine the “success” of previously executed triggers and then manually initiate a control signal 6 to generate a new trigger.

Interrelationship of Content, Ads and Triggers

Now that a content collaboration has been described, a further discussion of the relationship between displayed contents, advertisement and triggers is described herein.

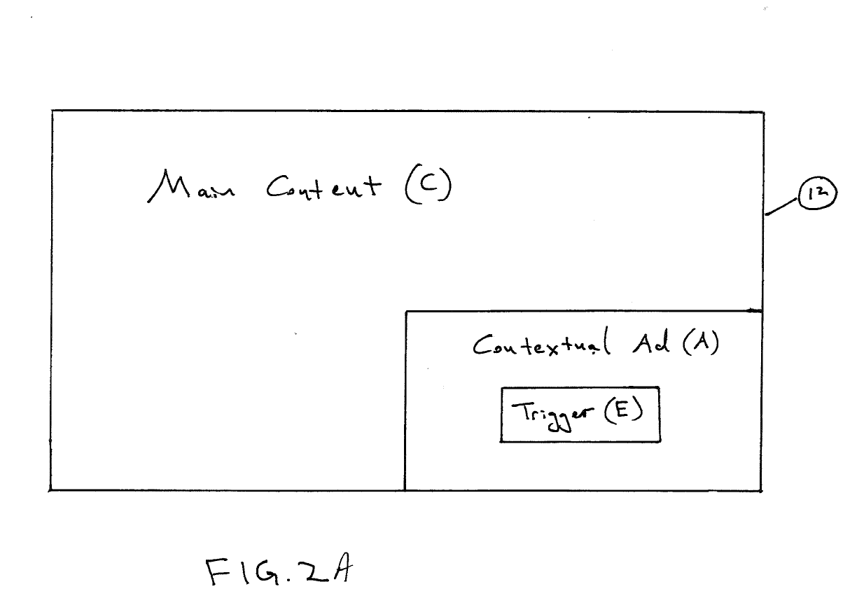

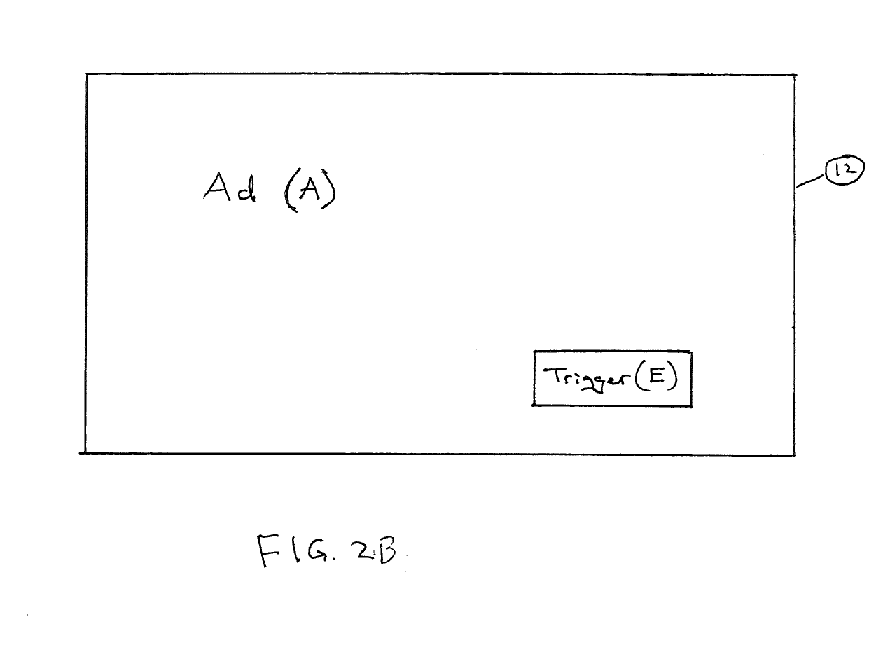

FIG. 2A is a billboard 12 showing the general relationship between a main content (C), a contextual advertisement (A) and a trigger (E), in accordance with an example embodiment. Specifically, the billboard 12 may include a main content (C) such as a public service message or a scenic photograph or a main content of an Internet website. The billboard may also include a contextual ad (A). The ad (A) may be a smaller component of the content (C), such as a banner of a webpage that includes the advertisement. Alternatively, the main content (C) may not exist and the billboard 12 may only be the ad (A) itself. Alternatively, the billboard 12 may only include content (C) such as a public service message, and no ad (A) may exist. The trigger (E) may exist on the billboard as an identifying number or instructions specifying how a viewer may execute the trigger. Alternatively, the trigger (E) may be a field on an internet website that a viewer may select to instantly execute the trigger. Furthermore, the trigger (E) may be a coupon that a viewer may print from a webpage to later redeem at a vendor's store.

It is important to note that the actual execution of the trigger (E) may occur at a location that is a distance away from the actual billboard (for instance, a trigger (E) included in a billboard at the state fair may be redeemed by viewers through their local school district). The actual execution of the trigger may also occur at a point in time that is much later than the actual viewing of the trigger (for instance, the trigger (E) included in the billboard at the state fair may execute by members of the school district at the end of the school year). Therefore, the trigger (E) may be executed at a point in time and a place in time that is very different from the initial viewing of the trigger (E) on the billboard 12 itself.

The following equation further describes the relationship between a trigger and the other parameters of the content collaboration system.

Eᵢⱼₖ=f(Aᵢ,h,Cₖ,Tᵢⱼₖ) Equation 1

Aᵢ=ads in ad inventory (Aᵢ, A₂, . . . , Aₘ)

Lⱼ=location of billboard (L₁, L₂, . . . ,

Cₖ=content available in content inventory (C₁, C₂, . . . , C_{q})

Tᵢⱼₖ=time interval of A shown at location Lⱼ with content Cₖ

Therefore, according to Equation 1, trigger Eᵢⱼₖ is a function of the time interval or time duration upon which ad A is shown on billboard location Lᵢ along with content Cₖ.

To provide another specific example, A may be a shoe ad, Cₖ may be a picture of a store where the shoe is available, and location Lⱼ may be a location of many billboards owned by a billboard owner that have been placed in internet advertisements, television advertisements, and various billboards within regional movie theatres and shopping malls in a geographic area. The goal of the billboard owner is to maximize cumulative viewership of all of the shoe ads Aᵢ across the billboards in the region during a period of time (the period of time Tᵢⱼₖ may be a first week of the shoe ad campaign). A group of people traveling through the mall may see several of the owner's billboards including the shoe advertisement Aᵢ. However, if each billboard in the region only displays the same shoe ad Aᵢ, the billboard owner loses revenue due to a reduced number of distinct ads for other products that could otherwise have been viewed by unique consumers. Furthermore, in some cases the billboard owner may purposefully want the same shoe ad Aᵢ to be seen by a consumer multiple times. However, without a means of tracking how many times the shoe ad Aᵢ has actually been seen, the effectiveness of the billboard may remain unknown.

Therefore, the billboard owner may provide a trigger to gauge the viewership and effectiveness of each billboard displaying the shoe ad Aᵢ. The trigger may be the same for each shoe ad Aᵢ among each of the heterogeneous media, or the trigger may be different for each type of media in order to track the effectiveness of the media type itself. For instance, trigger Eᵢⱼₖ for all Internet ads (location being Internet ads) may be a unique lottery number that a viewer may text using a cell phone, for a chance to win a sports car. The trigger E_{ifk} for all billboard ads within the mall (location L_{f} being mall ads) may also be a lottery number that a viewer may text using a cell phone for a same chance to win the sports car. The two triggers both ensure that a same viewer has an equal interest in executing the trigger, as the “prize” for both triggers is a chance to win the same “prize” (i.e., the sports car). However, the lottery number for the E_{ifk} k trigger (the trigger for the mall ad) may be a different unique lottery number than the lottery number used for the internet ad. This will allow the billboard owner to track the effectiveness of the separate internet and mall advertisements. By obtaining feedback on the effectiveness of all content/ads placed in different locations at different times and using different heterogeneous media, the billboard owner may then use triggers to determine the effectiveness of location, time, and/or chosen media to then provide a collaborated billboard campaign.

Further Examples of Collaboration

Collaboration among triggers, content and ads can take various forms. Three major types of collaboration may be as follows.

1. Sectional Collaboration: Collaboration that limits itself to only a portion of all billboards. For instance, a trigger included in an ad, where the trigger may or may not be related to advertisement.

2. Embedded Sectional Collaboration: Embedded sectional collaboration refers to sectional collaboration that is further embedded inside another content. For instance, a trigger included in an ad that is embedded in content. The trigger may or may not be related to the content and/or the ad.

3. Exhaustive Collaboration: Collaboration that occupies the entire billboard. For instance, a billboard that only displays a trigger. A specific example of this may be a billboard that only includes information providing a coupon with a unique identifier for a free item at a local mall. Another example may include a content or an ad that may be displayed on the billboard as a direct result of an output of the trigger generator. In other words, the content/ad displayed on one particular billboard is the result of executed triggers involving one or potentially many other billboards.

Of the above examples of collaboration, embedded sectional collaboration is of particular interest. Embedded sectional collaboration increases the number of “keen eyeballs” because it provides viewers with a reason to seek out the embedded trigger and in doing so the viewers are actively seeking out the enveloping content and the ad. “Keen eyeballs” is a count of the number of viewers actively viewing and/or searching the billboard for info nation. Viewers with “keen eyeballs” are different from a great number of viewers nowadays that subconsciously or purposefully ignore and/or gloss over billboards as they are often desensitized from constant exposure to advertisements and messages throughout their daily lives. An increase in “keen eyeballs” on a billboard, rather than a mere increase in the number of eyeballs on a billboard, translates into a higher CPM (cost per mile) that may be charged for a particular ad.

Therefore, embedded sectional collaboration causes value to move from the trigger, to the ad containing the trigger, to the content containing the trigger and the ad (i.e., movement of value can move as follows: E (trigger)→A (ad)→C (content)). For this reason, selection of an embedded trigger may be based on the relevance of the embedded trigger as the trigger relates to the ad and/or the content.

A content collaboration method and arrangement having been described above, a method of determining the relevance of embedded triggers based on a selected ad and/or content is described below.

Determining Relevance

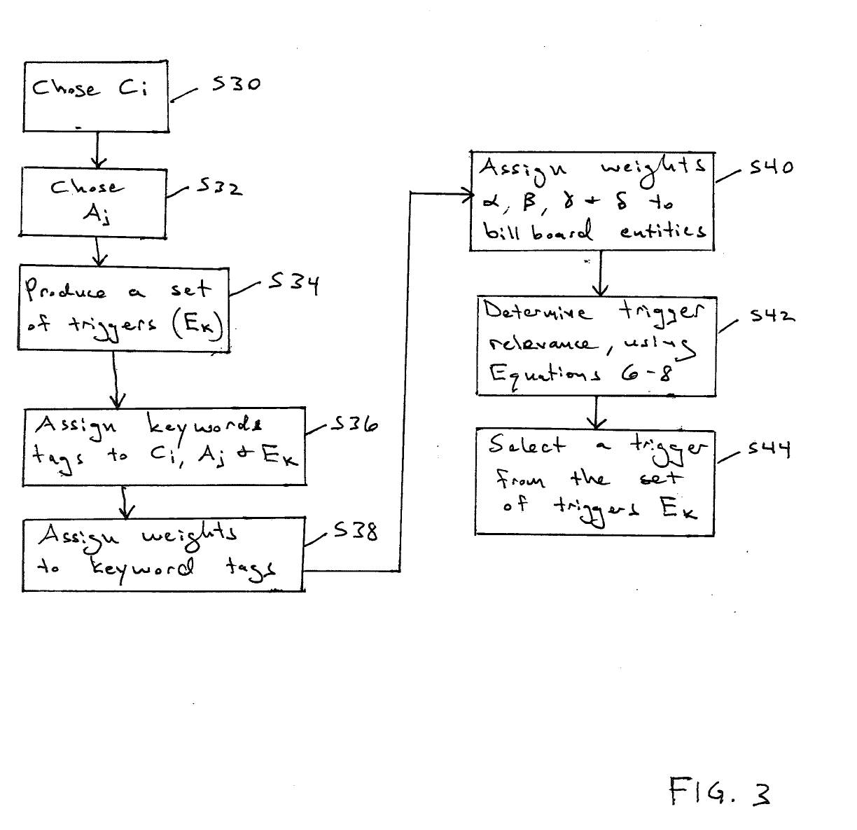

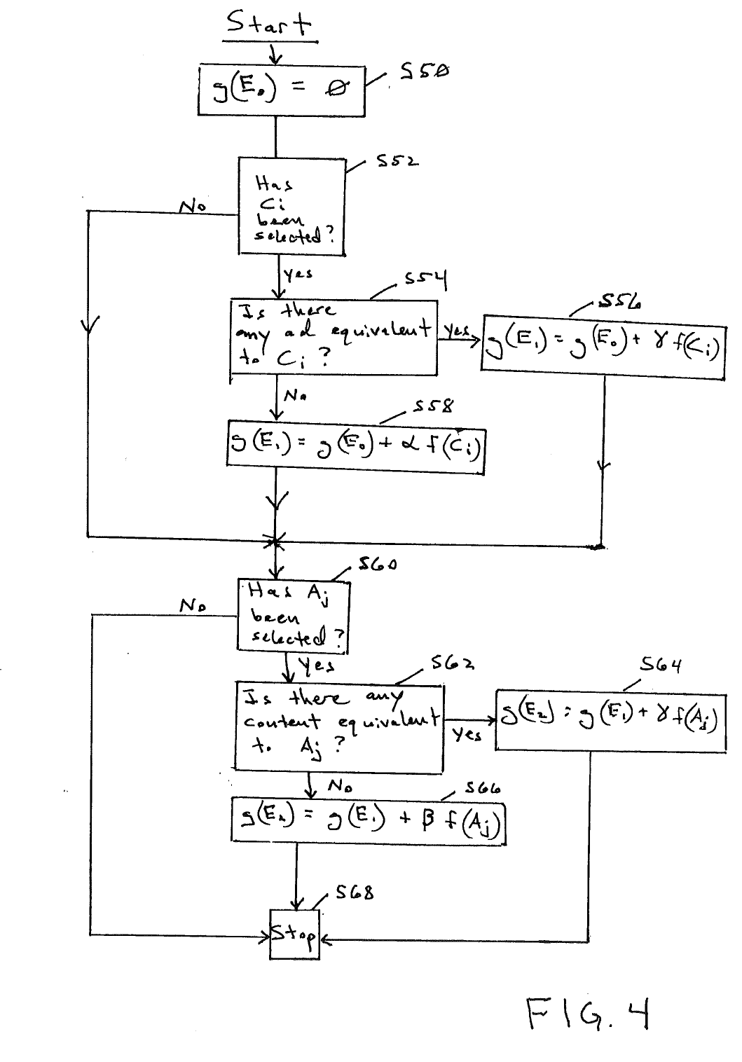

In order to select an appropriate embedded trigger, a measure of the relevance of the trigger to either an ad or content is helpful information. Example embodiments provide a method of determining the relevance of a finite (and, known) set of embedded triggers, based on a selected ad and/or content that is to be displayed on a billboard. In other words, given a finite set of triggers and knowing the ad and/or content that is to be displayed, the relevance of each trigger may be determined as they relate to a chosen ad and/or content (an example embodiment of this method if shown in FIG. 3). Example embodiments also provide a method of determining a “potential” relevance of a theoretical (i.e., unknown) embedded trigger, based on a selected ad and/or content. In other words, without having a set of embedded triggers in mind, the “potential” relevance of a fictitious trigger (i.e., a trigger that has not be created yet) may be determined based on a chosen ad and/or content (an example embodiment of this method is shown in FIG. 4).

To determine “relevance,” keywords may be assigned to potential triggers, ads, content and global content (as discussion of global content follows). This may allow potential triggers to be sorted and prioritized. This may also allow triggers to be selected for a chosen ad and/or content, as well as better triggers to be designed in order to be more relevant to a chosen ad and/or content. In all cases, the strategy behind these methods is to increase the value of the ad and/or the content, by using an appropriate and relevant trigger. As a general rule, the more relevant the trigger is to either the ad or the content, the more value the ad/content may derive from the trigger.

Embedded triggers may most often be implemented in one of two major forms. The first form is shown in FIG. 2A, where a billboard 12 may include a main content (C), a contextual advertisement (A) and an embedded trigger (E). A second possible form is shown in FIG. 2B, where a billboard 12 may only include the ad (A) and an embedded trigger (E) (it is noted that less frequently used forms of triggers may include a billboard with only content and a trigger, or a billboard with only a trigger and nothing else).

Using FIG. 2A as an initial guide, the three major entities involved in billboard 12 include: 1) Content (C), 2) Ad (A), and 3) Trigger (E). A fourth entity may be labeled “global” content (G). Global content is defined in Equation 2, below. Equation 2 indicates that everything that is not “content” or “ad” may be considered “global” (i.e., global falls under neither ad, nor content, but instead is “everything else”).

G=C′∩A′ Equation 2

If symbol “←” represents the dependency of context (X) on another content (Y) (i.e., X←Y), this means that parameters of X are entirely modulated or controlled by parameters of Y. Therefore, Equation 3 may be used to describe the relevance of trigger (E) as a function of the entities shown in FIG. 2A.

E←αC+βA+γ(A∩C)+δG Equation 3
where α+β+γ+δ=1

In other words, the trigger may be specified as a function of “entity weights” (α, β, γ and δ) assigned to content only, ad only, the intersection of content/ad (in the event that the ad is a part of the actual content itself) and global content, respectively. By assigning the weights, a billboard operator may emphasize the importance of the content, the ad, the portion of the ad and content that is in common, or the global content. Assignment of the weights may relate for instance to the revenue that may be generated by the content provider or the ad provider in order to display the ad/content on the billboard. Note that FIG. 2B is a special case of Equation 3, where α=γ=0. If the billboard operator of FIG. 2B sets δ=0 as well, the relevance of the trigger may be based on the ad portfolio alone.

Assuming that a finite set of triggers, content, ads, and global content exist, the trigger “items” may be indexed as E1, E2, E3 through E_{L}, content items may be indexed as C1, C2, C3 through C_{Q}, ad items may be indexed as A1, A2, A3 through A_{M} and the global content may be indexed as G1, G2, G3 through G_{N}. It is noted that an “item” signifies a discrete trigger (e.g., trigger E1), a discrete content (e.g., C2), a discrete ad (e.g., A3), and so on. In other words, an “item” is a specific selection of an entity (an entity being a “trigger,” a “content,” an “ad,” or “global”) from a portfolio of possible choices for the entity. The index for representing “items” may be Ci, Aj, Ek and Gm, respectively, for content, ads, triggers and global content. In other words, Ci may represent any one of the individual items of content, such as C1, or C2, and so on through C_{Q}. Likewise, Aj, Ek and Gm also may represent any one of the individual items in the set of ads, triggers, and global content, respectively. Priorities may then be assigned to the importance of sets of content C and ads A, using weights α and β, respectively. Additionally, if some items belong to both content and ads, a priority using weight γ may be assigned to those items. Any items not classified as content or ads are assigned a priority using weight δ.

Each item of the entity portfolios may then be described using a set of keywords (“keywords” are tags/descriptors used to describe the item). For instance, keywords for an “item” that is a Nike shoe ad may include {shoe, sneaker, Nike, running, footwear, feet, athletic}. Therefore, the set of tags for any item p may be defined as T(p), where p is an item of super set S={{Ci}, {Aj}, {Ek}, {Gm}}. If two items p and have the same set of tags, we may state that the items are equivalent (i.e., p=q).

Each tag that is used for an item may have a weight (w(t)) associated therewith. The weight may be indicative of the price that an advertiser is willing to pay, for example. Or, the weight may reflect a priority among the set of tags, based on other subjective measures. For instance, the weights may be determined based on historical context, across all displayed content and ads of all billboards over a period of time. As advertisers know, some keywords or phrases are more successful at selling items, and therefore the keywords may be weighted based on industry experience. Additionally, the weights assigned to keywords may change over time, or seasonally. For instance, the keyword “cold” may be assigned a higher weight during the summer because the image of a cold product (for example, a cold beverage, or ice-cream) may have greater value in warm weather.

Once weights are assigned to keywords, the cumulative weight of an item p in superset S may be given by f(p), where f(p) is a sum of all of the weights of each tag associated with the item, as shown in Equation 4, below.

f(p)=Σw(t), where t belongs to the set of all tags T(p) Equation 4

Trigger Selection (Determine Relevance of E, given C/A):

When a content Ci and an advertisement Aj have been selected, it is beneficial to determine the relevance of each trigger Ek (in a set of finite triggers) as they relate to the selected content/ad. A determination of relevance may then be used to select a trigger to most effectively increase the value of the ad or the content within the display/billboard. Therefore, let Ci and Aj be known. Keyword tags for the content and ad may be represented by T(Ci) and T(Aj), respectively. Equation 5 may then be used to identify a subset of all triggers (i.e., all triggers in set E) with at least one keyword tag in common with either the content or the ad.

T(p)∩(T(Ci)∪T(Aj))≠Ψ, for all p belonging to set E Equation 5

Let the trigger items satisfying Equation 5 be X. X is therefore a subset of E. For each item p in the set X, a relevant tag-weight of item p may be deter mined by the following steps.

Determining the Relevance Value of an Item:

1. For each item p in the set X,

2. c(p₀)=0=initial relevance

3. c(p₁)=c(p₀)+Σa(w(t)), where t belongs to the set T(p)∩(T(Ci)\T(Aj)) Equation 6

4, c(p₂)=c(pᵢ)+Σβ(w(t)), where t belongs to the set T(p)∩(T(Aj)\T(Ci)) Equation 7

5. c(p₃)=c(p₂)+Σγ(w(t)), where t belongs to the set T(p)∩(T(Aj)∩T(Ci)) Equation 8

Each summation (Σa(w(t)), Σβ(w(t)) and Σγ(w(t))) included in Equations 6-8 is considered an “entity relevance value,” for a particular item p (item p being a particular trigger). Notice that in Equation 6, the entity relevance value for content, Σα(w(t)), is determined by multiplying entity weight of content, α, by a summation of all keyword weights of keywords associated with both the trigger and the content, but not the ad (thus, the meaning of “T(p)∩(T(Ci)\T(Aj)”). Likewise, in Equation 7, the entity relevance value for the ad, Σβ(w(t)), is determined by multiplying the entity weight for the ad, β, by a summation of all keyword weights of keywords associated with both the trigger and the ad but not the content (thus, the meaning of “(T(p)∩(T(Aj)\T(Ci))”). Lastly, in Equation 8, the entity relevance value for the intersection of ad and content, Σγ(w(t)), is determined by multiplying the entity weight for ad/content, γ, by a summation of all keyword weights of keywords associated with the trigger, the ad and the content (thus, the meaning of “T(p)∩(T(Aj)∩T(Ci))”).

The final value c(p₃), shown in Equation 8, signifies the “relevance value” for the item p (item p, being a particular trigger). Repeating steps 2-5, shown above, for each item p in the set X provides a relevance value for each trigger.

Using the relevance value of triggers, a billboard operator may select, for instance, the trigger with the highest relevance value. Alternatively, the billboard operator may select the top 10 triggers with the highest relevance value. The value of relevance may also be used, for comparison purposes, to determine if the given set of triggers E offers enough relevance that they may be used for the pre-selected content and ad (or, alternatively, the value of relevance may be used to determine if better triggers may need to be created).

An Application for Determining Relevance

A simple application of the determination of the relevant tag-weight for trigger items is now provided. Method steps involved in the determination relate to FIG. 3. All of these method steps may take place in the trigger generator of 22, as shown in FIG. 1 (and as described above).

In step S30 of FIG. 3, content Ci may initially be chosen. The content may be chosen by the trigger generator 22 randomly (from the available content included in content server 24), or human interaction may be used to choose the content. For exemplary purposes, let us assume that Ci is a movie clip about snow skiing at a mountain resort.

In step S32, an ad Aj, that may be played before of after the movie may also be chosen. The ad may again be chosen by the trigger generator randomly (from the ads available in the ad server 26), or human interaction may be used to choose the ad. Again for exemplary purposes, let us assume that Aj is an ad (Aj) for a particular type of beer.

In step S34, a set of potential triggers Ek are produced. The trigger generator 22 may determine the available set of triggers based on the triggers that are available in trigger server 28, shown in FIG. 1. Alternatively, human intervention may be used to select the potential triggers. Let us assume that two triggers are selected. The triggers may include, 1) E1—a coupon for cold beer in a mountain lodge resort, 2) E2—a coupon for hot coffee in a coffee shop in the mountain lodge resort.

In step S36, keyword tags may be assigned to all of the entity “items,” as shown in the example below. The keywords may be manually assigned to items when items are first added to the content server 24, the ad server 26 and trigger server 28, respectively. Alternatively, the content server 24, ad server 26 and trigger server 28 may automatically assign the keyword tags based on the use of these words in each item. Additionally, the trigger generator 22 may automatically assign the keywords based on the use of these words in each item.

T(Ci)={ski, resort, cold, winter}

T(Aj)={beer, cold, beer manufacturer, bottle}

T(E1)={beer, cold, resort, discount}

T(E2)={coffee, name of coffee shop, resort, discount}

In step S38, the weight of the keyword tags may be assigned (for later use in Equation 4), as shown in the following example. The weights may be determined based on advertising industry experience (specifically, an emphasis on keywords that more effectively sell products may cause a keyword to be assigned a higher weight). The weights may also be subjectively assigned based on the primary messages that the advertiser may want to convey to consumers. The weights may be manually entered in the trigger generator 22 (or alternatively they may be manually entered in the content server 24, the ad server 26 and trigger server 28, respectively). In this case, the advertiser is trying to sell beer, and for that reason the word “beer” is assigned the highest weight.

w(beer)=5

w(ski)=2

w(all other words)=1

In step S40, weights (α, β, γ and δ, as shown in Equation 3) for the entities displayed in the billboard may also be determined. These weights may be manually entered in the trigger generator 22 (or alternatively they may be manually entered in the content server 24, the ad server 26 and trigger server 28, respectively). For exemplary purpose, the billboard operator is generating 80% of all revenue from the producer of the movie and only 20% from the ad. Additionally, no global content is included. The advertisement for the beer is being shown either before or after the movie. Therefore, the ad is not actually part of the content (the movie) itself, meaning that γ is assigned a value of zero. For these reasons, the billboard operator is more interested in ensuring that the trigger is relevant to the movie (the major source of revenue for the billboard operator), and less interested in providing a relevant trigger for the ad. Therefore, the appropriate weights are assigned as shown below.

α=0.8

β=0.2

γ=0

δ=0

In step S42, the relevance of the two triggers may then be determined using Equations 6-8. For E1, relevance is calculated as follows.

c(p₀)=0

Note that the keywords “ski” (with weight of 1) and “cold” (with a weight of 1) are included in both E1 and Ci, and therefore c(p₁) is calculated as follows.

c(p₁)=c(p₀)+Σα(w(t))=0+0.8(1+1)=1.6 Equation 6

Note that keywords “beer” (weight of 5) and “cold” (weight of 1) are included in both E1 and A1, and therefore c(p²) is calculated as follows.

c(p₂)=c(p₁)+Σβ(w(t))=1.6=0.2(5+1)=2.8 Equation 7

Because γ=0, c(p₃) is calculated as follows.

c(p₃)=c(p₂)+Σγ(w(t))=2.8+0=2.8 Equation 8

Relevance is also calculated for E2, as follows.

c(p₀)=0

c(p₁)=c(p₀)+Σα(w(t))=0+0.8(1)=0.8 Equation 6

c(p₂)=c(p₁)+Σβ(w(t))=0.8+0.2(0)=0.8 Equation 7

c(p₃)=c(p₂)+Σγ(w(t))=0.8+=0.8 Equation 8

In step S44, one or more triggers may be selected from the set of triggers Ek. Because E1 has a determined relevance of 2.8 and E2 has a determined relevance of 0.8, a billboard operator may likely wish to use E1 in the billboard. However, other criteria may be used for the selection of the trigger. For example, several triggers may be chosen based on a threshold value of relevance. The ultimate selection of the trigger may be accomplished automatically, by trigger generator 22 (for instance, trigger generator 22 may simply chose the trigger with the highest relevance). Alternatively, human intervention may be used to subjectively review the triggers, in light of the relevance information, whereby a person may manually cause trigger generator 22 to select the one or more triggers.

Even after a trigger is selected, a billboard operator may be interested in knowing the “potential” relevance of a trigger, given a specific content and/or ad that is to be displayed on a billboard. That is to say, the above method of determining the relevance of triggers was based on an a priori listing of potential triggers. However, for a particular content and/or ad, it may be helpful to determine the “potential” for a theoretical trigger (i.e., a trigger that may not exist, at the outset of the method). By understanding the “potential” relevance associated with content and/or an ad, the billboard operator may gain an understanding of how relevant the chosen trigger is compared to this potential. Likewise, knowing the “potential” relevance, the billboard operator may determine that better triggers should be developed, in lieu of using one or more of the triggers in the a priori trigger list.

“Potential” Relevance of Trigger (given C/A):

“Potential” relevance is a measure of relevance that may be attained, following selection of content and/or an ad. This is the potential that may be realized, if a trigger were designed to meet such potential. To illustrate the determination of potential relevance, the previous content Ci (a movie clip about skiing in the snow in a mountain resort) and ad Aj (an ad for a particular type of cold beer, shown before or after the movie) may be used.

FIG. 4 is an example embodiment of a method that may be used to determine potential relevance. Each of the method steps included in FIG. 4 may be accomplished automatically by trigger generator 22. Or alternatively, each of the steps may be manually entered and/or accomplished by a billboard operator and then entered into the trigger generator 22.

FIG. 4 takes into account the scenario where content is selected, but an ad has not yet been selected. FIG. 4 also takes into account the scenario where an ad has been selected, but content has not been selected. Furthermore, FIG. 4 takes into account the scenario where content and an ad have both been selected. In all cases, it is important to note that an a priori listing of triggers is not required, nor reflected, in the FIG. 4 method.

Viewing FIG. 4, in step S50 the initial potential relevance is set to zero. In step S52, a determination is then made as to whether content has been selected. This determination may automatically occur at the trigger generator 22 or the content server 24 shown in FIG. 1. Alternatively, the determination may simply be manually selected by a billboard operator, and entered into the trigger generator 22. Using the example of a skiing movie (content) with a beer advertisement, the content has been preselected and therefore method step S54 is performed next. If content had not been preselected, then method step S60 would have been performed next.

In step S54, a determination is made as to whether there is an ad that is “equivalent” to the preselected content. An ad is “equivalent” if all keyword tags for the ad are the same as the content. In other words, the “equivalent” ad may, in essence, take the place of the content, and vice versa. If there is an ad that is equivalent to the content, then in step S56 a value of relevance is determined using Equation 9, shown below.

g(E₁)=g(E₀)+γf(Ci) Equation 9
where f(Ci)=Σw(t), as shown in Equation 4

The product γf(Ci) is an “entity value” for the intersection between the preselected content and the equivalent ad. The value γ is the “entity weight” for the intersection between the content and the ad. And the value f(Ci) is a summation of all keyword weights associated with the preselected content.

Using our example of the movie clip with an ad for beer, the movie clip and the beer ad are not equivalent (all keyword tags are not equal, for both the content and ad). And no other ads are available in the ad portfolio of the ad server 26 of FIG. 1. Therefore, using the method of FIG. 4, step S58 is instead used to determine the value of potential relevance related to the content, using Equation 10 shown below.

g(E₁)=g(E₀)+αf(Ci) Equation 10
where f(Ci)=Σw(t), as shown in Equation 4

The product αf(Ci) is a content “entity value” for the preselected content. The value α is the “entity weight” of the content.

Using the keyword tags for Ci assigned above (T(Ci)={ski, resort, cold, winter}) and the value of 0.8 for α, g(E) is calculated as shown below. This calculation may be performed automatically at the trigger generator 22, or the value of g(E) may alternatively be manually entered into the trigger generator 22.

g(E₁)=0+0.8*(2+1+1+1)=4

In step S60 of FIG. 4, a determination is made as to whether an ad has been preselected. In our example, the cold beer ad has been selected and therefore the method proceeds to step S62. If however no ad was selected, the method then proceeds the end (in step S66).

In step S62, a determination is made as to whether there is any content that is equivalent to the preselected ad. In our example, the skiing movie is not equivalent to the cold beer ad. And, no other content is available in the content portfolio of the content server 24 of FIG. 1. Therefore, Equation 11 (shown below), and in step S64 of FIG. 4 is not used to determine the potential relevance of the ad.

g(E₂)=g(E₁)+γf(Aj) Equation 11
where f(Aj)=Σw(t), as shown in Equation 4

The product γf(Aj) is an “entity value” for the intersection between the preselected ad and the equivalent content. The value γ is the “entity weight” for the intersection between the content and the ad. And the value f(Aj) is a summation of all keyword weights associated with the preselected ad.

Therefore, the method instead proceeds to step S66. In step S66, the potential relevance of the ad is calculated using Equation 12, as shown below.

g(E₂)=g(E₁)+βf(Aj) Equation 12
where f(Aj)=Σw(t), as shown in Equation 4

The product βf(Aj) is an ad “entity value” for the preselected ad. The value β is the “entity weight” for the ad. And the value f(Aj) is a summation of all keyword weights associated with the preselected ad.

Using the values of g(E₁)=4 and β=0.2, and adding the weights of the assigned ad keyword tags (T(Aj)={beer, cold, beer manufacturer, bottle}), g(E₂) is calculated as shown below.

g(E₂)=4+0.2(5+1+1+1)=5.6

Following a determination of g(E₂) (the “potential” relevance of the preselected skiing movie with cold beer ad), the method of determining potential relevance ends at step S68.

Knowing the value of potential relevance, a billboard operator may now compare the value of potential relevance (g(E₂)=5.6) of the preselected skiing movie/cold beer ad to the relevance of the two triggers (c(p₃)_{E1}=2.8 and c(p₃)_{E2}=0.8). Using this information, the billboard operator may determine that a threshold value of a selected trigger must exist. For instance, a threshold value may be determined by multiplying the potential relevance value by a multiplier, such as 0.8. The billboard operator may then ensure that all selected triggers have a relevance value that is above the threshold (i.e., that is above 80% of the potential relevance of the selected content and/or ad).

Using our example, potential relevance (g(E₂)) is 5.6, and therefore a threshold relevance value for the triggers may be 0.8(5.6)=4.48. Because 4.48 would be the minimum value of relevance that a trigger would need to have to be used in the skiing movie with cold beer ad, the current set of triggers (with relevance values c(p₃)_{E1}=2.8 and c(p₃)E₂=0.8) do not meet this threshold. Therefore, the billboard operator may determine that a better set of triggers should be developed that offer a higher value of relevance, as compared to the determined “potential” relevance of the preselected content and ad.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of determining a relevance value for triggers to be displayed on a billboard, the method comprising:
selecting, by a trigger generator, a content from a content server;
selecting, by the trigger generator, an ad from an ad server;
selecting, by the trigger generator, a first trigger from a trigger server;
assigning an entity weight to each entity to be displayed on the billboard;
determining, by the trigger generator, an entity relevance value of the first trigger for each entity;
determining, by the trigger generator, a first relevance value of the first trigger by summing the entity relevance values; and
selectively displaying the first trigger based on the determined first relevance value.

2. The method of claim 2, wherein the entities to be displayed on the billboard include the content with an entity weight α, the ad with an entity weight β, and an intersection of the content and the ad with an entity weight γ.

3. The method of claim 2, wherein the entities to be displayed on the billboard further include a global content with an entity weight δ.

4. The method of claim 1, wherein a summation of the entity weights equals the value of 1.

5. The method of claim 1, further comprising:
assigning keyword weights to keywords associated with each entity.

6. The method of claim 5, wherein the determining of the entity relevance value for each entity comprises:
multiplying each entity weight by a summation of the keyword weights of the first trigger that are associated with each entity.

7. The method of claim 1, wherein the assigning of the entity weights to each entity further comprises:
prioritizing the entities based on generated revenue; and
ensuring that the assigned entity weights reflect the prioritizing of the entities based on the generated revenue.

8. The method of claim 5, wherein the assigning of the keyword weights further comprises:
tracking the use of keywords in advertising over a period of time;
prioritizing the keywords based on generated revenue for each keyword; and
ensuring that the assigned keyword weights reflect the prioritizing of the keywords based on the generated revenue.

9. The method of claim 2, wherein the determining of the entity relevance values further comprises:
assigning keyword weights to keywords associated with each entity;
determining a first entity relevance value for the content, by multiplying a first entity weight by a summation of the keyword weights of keywords associated with both the first trigger and the content but not the ad;
determining a second entity relevance value for the ad, by multiplying a second entity weight by a summation of the keyword weights of keywords associated with both the first trigger and the ad but not the content;
determining a third entity relevance value for the intersection of ad and content, by multiplying a third entity weight by a summation of the keyword weights of keywords associated with the first trigger, the ad and the content.

10. The method of claim 1, further comprising:
selecting a second trigger from the trigger server;
determining a second entity relevance value of the second trigger for each entity;
determining a second relevance value of the second trigger by summing the second entity relevance values.

11. The method of claim 10, further comprising:
comparing the first relevance value against the second relevance value,
the selectively displaying of the first trigger based on the determined first relevance value including selecting the trigger with the highest relevance value as the trigger to be displayed on the billboard.

12. The method of claim 1, wherein either the content server or the ad server contain only a null set, such that the trigger is displayed on the billboard with only the content or only the ad.

13. A method of determining a potential relevance, comprising:
determining, at a trigger generator, if a content has been preselected;
computing, at the trigger generator, a content entity value for the preselected content, if the content has been preselected;
determining, at the trigger generator, if an ad has been preselected;
computing, at the trigger generator, an ad entity value for the preselected ad, if the ad has been preselected;
determining, at the trigger generator, the potential relevance by summing the entity values; and
selectively displaying a trigger, at a billboard, based on the determined potential relevance, the trigger being displayed with the preselected content and/or the preselected ad.

14. The method of claim 13, further comprising:
evaluating whether there is an ad that is equivalent to the preselected content, if the content has been preselected;
the computing of the content entity value including multiplying an entity weight for the intersection of the preselected content and the equivalent ad by a summation of keyword weights associated with the content, if there is an equivalent ad;
evaluating whether there is a content that is equivalent to the preselected ad, if the ad has been preselected;
the computing of the ad entity value including multiplying the entity weight for the intersection of the preselected ad and the equivalent content by a summation of keyword weights associated with the preselected ad, if there is an equivalent content.

15. The method of claim 14, further comprising:
the computing of the content entity value including multiplying a content entity weight by a summation of the keyword weights associated with the content, if there is not an equivalent ad;
the computing of the ad entity value including multiplying an ad entity weight by a summation of the keyword weights associated with the preselected ad, if there is not an equivalent content.

16. The method of claim 13, wherein a summation of the entity weights equals the value of 1.

17. The method of claim 15, further comprising:
prioritizing the entities based on generated revenue; and
ensuring that the entity weights reflect the prioritizing of the entities based on the generated revenue.

18. The method of claim 15, further comprising:
tracking the use of keywords in advertising over a period of time;
prioritizing the keywords based on generated revenue for each keyword; and
ensuring that the keyword weights reflect the prioritizing of the keywords based on the generated revenue.

19. The method of claim 13, further comprising:
setting a threshold relevance value for triggers, based on the potential relevance,
the selectively displaying of the trigger based on the determined potential relevance including displaying the trigger if the relevance value of the trigger is greater than the threshold relevance value.

20. The method of claim 19, wherein the setting of the threshold relevance value includes multiplying the potential relevance by a multiplier of 0.8.
